(19) United States
(12) Patent Application Publication
(10) Pub. No.: US 2003/0124498 A1
(43) Pub. Date: Jul. 3, 2003

(54) Yan-Koloba: an educational teamwork and character building block game

(76) Inventor: Emmanuel Ngomsi, Kansas City, MO (US)

Correspondence Address: EMMANUEL NGOMSI, Ph.D., 15804 EAST 78TH STREET, KANSAS CITY, MO, 64139, US

(21) Appl. No.: 10/045,107

(22) Filed: Jan. 3, 2002

(51) Int. Cl. G09B 19/00

(52) U.S. Cl. 434/237

(57) ABSTRACT

A method of playing an educational group game for familiarizing the players with the concepts of teamwork, collaboration and responsibility, promoting tolerance and trust, self-esteem and leadership development, with respect to typical African culture and tradition. Following specific placement patterns, players of all cultural backgrounds and ages sit on the floor or at desks in a closed playing area. The purpose of the game is to move wooden blocks simultaneously, rhythmically and consistently among players within the closed area. Three to fifty players pick up the blocks in front of them, draw specific designs as instructed by the game facilitator, tap the blocks in front of their neighbors to the right or to the left and leave them there, while singing the accompanying song, under the guidance of the game facilitator who coordinates all major components of the game. Under great concentration, players challenge themselves not to accumulate more than one block in front of them at any time. The game presents numerous variations based on methods and outcomes, including a win-win outcome, a method of elimination, and a competitive but non-confrontational variation.

### 2. CROSS REFERENCE TO RELATED APPLICATIONS

Not Applicable

### 3. BACKGROUND OF THE INVENTION

1. Field of Invention

The present invention relates to the field of techniques of teaching teamwork using games in general. It relates more particularly to a developmental and educational team-building game using blocks, and requiring that players through a team effort, move blocks together and rhythmically as a team, in order to achieve their predetermined goal.

2. Description of the Related Art

It is universally known in the art that there exist a myriad of patented wooden block games. Johnson, III, U.S. Pat. No. 6,022,026, calls for staking block game, where players lay wooden blocks one on top of others. In U.S. Pat. No. 4,303,240, Ellman et al. describe a type of moving block game played by one or more players, in which players position blocks in a moving table. Lu, U.S. Pat. No. 5,080,370, discloses a block game which may be used by children for a variety of activities. Furthermore, Foley et al. in U.S. Pat. No. 3,454,279 describes a team game in which the players are engaged in competitions for spaces, and remains shy in highlighting the power of team building and the spirit of community and unity. Most team games promote group competition and highlight a looser. To date, there is no developmental team game designed to teach simultaneously character traits like respect, responsibility, harmony, tolerance, teamwork and unity in players of ages 5 through adult. The power of teamwork is in increasing demand in every aspect of any type of organization.

### 4. BRIEF SUMMARY OF THE INVENTION

A process of team and character building group activity that reaches across all cultural boundaries, fully delights and engages participants, teaching them respect and teamwork, collaboration and responsibility, promotes tolerance and trust, and boosts their self-esteem and leadership skills. Players sit on the floor, or sit or stand around desks, in a closed area shaped as a circle, a square or a rectangle forming a playing area. Players are close to each other enough to allow game blocks to be deposited in front of neighboring players. The game starts with each player holding a block in hand.

The purpose of the game is to move the blocks together, rhythmically and consistently to their neighbors within the circle, at a given speed. Acting simultaneously and rhythmically, up to 50 players pick up the blocks in front of them, draw specific designs as instructed by the game facilitator, tap the blocks in front of their neighbors to the right or to the left and leave them there, while singing the accompanying song. The game facilitator gives the signal to start the game, and calls players' names out, incorporating them into the song. buring the game players challenge themselves not to accumulate more than one block in front of them.

The game is developmental in the sense that it promotes in the players the ability to coordinate and develop at the same time, their visual, tactical and kinesthetic coordination, their oral and auditory capability, as well as their leadership skills. An unlimited number of teams can participate simultaneously, with a different facilitator in each team. This setting can serve as ground for competition among teams. The winning teams will be those which will successfully complete a set number of variations of the game at different game speeds, without its players failing to simultaneously and rhythmically pass the blocks to each other.

Unlike most team games, this invention does not highlight a looser, it rather promotes competition and challenge without confrontation. All 3 to 50 players move the blocks rhythmically, simultaneously and consistently, thus working together towards a common set of goals, and win together. This invention combines within the same plateau a simple game apparatus and team building concepts to take players to a higher level of communication and care for each other.

Objects of the present invention include:

To provide a team event for creating opportunity for players to challenge themselves intellectually, emotionally and physically in a fun and enjoyable team building environment.

To provide a multicultural team building game that can be played simultaneously by up to 50 players on the floor.

To provide a multicultural team building game that can be played simultaneously by up to 50 players at desks.

To provide a new educational game which is of easy, durable and reliable construction.

To provide a team building and educational game which is susceptible of a low cost of manufacture with regard to both materials and labor, and which accordingly is then susceptible to low prices of sale to the consuming public, thereby making such educational game available to a larger public.

To provide an intellectual and developmental game to promote in the players the ability to develop their visual and kinesthetic coordination, their oral and auditory capability, as well as their leadership skills.

To provide a very participatory team building game which is challenging for both the individual and the team, while promoting competition without confrontation, and a win-win outcome.

### 5. BRIEF DESCRIPTION OF THE DRAWINGS

Although no drawing seems to be necessary to describe the process which constitutes the objects of this invention, the following comments are to be considered with respect to the playing area and the placement of players, the playing apparatus and the music utilized in the game.

A. The playing area and placement of players. The game may be played on any surface where players may sit at an area shaped as a circle, a square or a rectangle, mainly in two main areas:

1. On the floor: The game may be played on the floor with players sitting in the shape of a circle. Players move the blocks to their neighbors on the floor inside the circle.

2. At desks: The game may be played at desks with players sitting on chairs facing the desks, or standing around the desks facing the center of the closed area. Players move the blocks to their neighbors on the desks.

B. The playing apparatus may be comprised of:

1. Blocks which may be wooden blocks of the same or different sizes.

2. Blocks which may also be made out of other materials such as plastic, sponge, foam.

3. Playing apparatus may also be sewed spheric of no more than 2 inches diameter, containing sand or any other suitable material.

C. The musical lyric chanted during the game by all the players is a one word easy to learn and to sing traditional African song which incorporates all players' names. As the game starts, the game facilitator strikes up the song by singing the solo, and the players repeatedly and alternatively with the facilitator sing the refrain. The chant includes two parts: The solo and the refrain.

1. The solo part of the song is comprised of players' first names in front of which the word “Mami” is added for female players (i.e. Mami Nancy), and “Papa” for male players (i.e. Papa Michael).

2. The refrain chanted by the players is a single word “Yan-koloba” said twice, which is also part of the title of the present invention:

“Yan-koloba heh-heh Yan-koloba.”

### 6. DETAILED DESCRIPTION OF THE INVENTION

The Method

In addition to the playing area and placement of players described in the drawing section, the method in this invention also includes a designated game facilitator and different ways of moving the blocks.

For the sake of full comprehension the present invention, it seem suitable to clarify the following words; 1) Facilitator; the game leader; 2) Pass the block: tap the block in front of a player, and leave it there. 3) Tap the block; Hit the floor or desks with a block and bring it back; 4) Variations; different ways of moving blocks.

Players may take turns leading the team as facilitators. The facilitator's role is to arrange the players in the playing area, instruct the players on the game procedures, teach the song and sing the solo during the game, decide on the duration of each round, and proceed to the elimination of players when necessary. The facilitator's position in the game depends on the playing area chosen. The game facilitator is encouraged to take part of the game as player.

Playing on the Floor

In the case the game is played on the floor with players sitting in the shape of a closed circle, square or rectangle, or any other closed area on the floor, the facilitator should either be within the circle as a player, or will circulate in the middle of the playing area. When taking part in the game as participant, the facilitator should play both the role of the player and the role of facilitator. The facilitator calls the players to order, asking them to stand in a circle, elbows up and out like wings. This ensures everyone has enough room to play. Then, the facilitator asks players to sit and stretch their legs out behind the person next to them and everyone's legs will go the same direction. The facilitator now rolls the blocks to the players, one block per player. Once the blocks are distributed, the facilitator asks that players hold their blocks like a computer mouse. The facilitator teaches the song by singing the refrain while tapping a block in front of him or her, and has the players repeat both activities. Then the facilitator strikes up the song by singing the solo. Players now tap their blocks on the floor in front of them, attempting to synchronize with the facilitator's voice. The game facilitator waits until players are singing and tapping together, then commands that players pass blocks to their neighbors, in the specified direction and variation.

Playing at Desks

In the case the game is played at desks, players are sitting on chairs facing the desks or standing around the desks facing the center of the closed area. The facilitator's position should preferably be within the group as a player, or around the circle behind the players.

The facilitator passes blocks to players, one block per player. Once the blocks are distributed, the facilitator asks players to hold their blocks like a computer mouse. The game facilitator teaches the song by singing the refrain while tapping a block in front of him or her, and have the players repeat both activities. Then the facilitator strikes up the song by singing the solo. Players now tap their blocks on the floor in front of them, attempting to synchronize with the facilitator's voice. The facilitator practices with players until all coordinate their singing and tapping together, then commands that players pass blocks to their neighbors, simultaneously and rhythmically in the direction and with the variation and speed specified by the facilitator. The method of passing the blocks as specified in this invention present numerous variations at various speeds and degrees of difficulty and challenge.

Variation 1: Regular Passing

In the regular passing, blocks are passed counter-clock wise. Players pick up the blocks up in front of them and pass them to their neighbors to the right, simultaneously, rhythmically and continuously, synchronizing with the leader's voice and the group chanting. In addition to the singing the leader begins to call players' names out, incorporating them into the song. This acknowledges and affirms each individual as member of the group. “Mami” or “Papa” is added to the beginning of each name dependent on whether the player is female or male. This is a sign of respect as well as a way to remind each player of their responsibility to take care of other members of the group.

Variation 2: Double Tapping

The game is played like in variation 1, except that players tap their blocks twice in front of them before passing them simultaneously, rhythmically and continuously to their neighbors, at the speed and to the direction determined by the facilitator.

Variation 3: Triple Tapping

Players will tap the blocks three times in front of them before passing them, simultaneously, rhythmically and continuously to their neighbors, at the speed and to the direction determined by the facilitator.

Variation 4: Left then Right Tapping

Players pick up the blocks, tap them in front of the players at their left, but do not leave them there. They bring the blocks back and tap them in front of themselves. Finally, they pass the blocks by tapping it in front of the players on their right, and leave there. This succession of events is conducted by all players simultaneously, rhythmically and continuously, at a speed determined by the facilitator.

Variation 5: Two Left and Right Tapping

Players pick up the blocks, first tap them in front of the players on their left, then in front of themselves, then in front of their players on their right, then in front of themselves, then in front of their neighbor on their left again, then in front of themselves and finally, they pass the blocks by tapping it in front of the players to their right, and leave them there. This succession of activities is conducted simultaneously, rhythmically and continuously by all players, at a speed determined by the facilitator.

Variation 6: The Low “L”

Players draw the capital letter “L” with their blocks before passing them. Players pick up their blocks, tap them first towards the middle of the circle with their arm extended, then bring them back to tap in front of themselves, and finally pass the blocks to their neighbors. This succession of activities is conducted simultaneously, rhythmically and continuously at a speed and direction determined by the game facilitator.

Variation 7: The Left and Right “L”

Players pick up their blocks, tap them first towards the middle of the circle with their arm extended, then in front of themselves, then tap them in front of their neighbors on their left, then in front of themselves, then towards the middle of the circle with their arm extended, then bring them back to tap in front of themselves, and finally pass the blocks to their neighbors. This succession of activities is conducted simultaneously, rhythmically and continuously at a speed determined by the game facilitator.

Variation 8: The High “L”

Blocks are moved like in variation 6, players pick up their blocks, tap them first towards the middle of the circle with their arm extended, then lift up their blocks approximately at the level of their eyes, then tap them down again at the extended position, then in front of them, and finally pass them to their neighbors. This succession of activities is conducted simultaneously, rhythmically and continuously at a speed and direction determined by the game facilitator.

Variation 9: The Fake Fist

This variation is played sitting or standing at desks, or sitting on the floor in a position which allows freely use of both hands. Both hands participate in this variation, but players are handling the blocks in their right hand only, the left hand is kept closed. First, players pick up the blocks with their right hand, both fists closed. Then they cross their arms and tap the blocks in front of your neighbor at their left. Do not leave the block there. At the same ti me, their left fists go towards their neighbor at their right. Players now uncross their hands, bring back the blocks and tap them in front of themselves, before tapping them in front of their neighbors and leave them there. This succession of activities is conducted simultaneously, rhythmically and continuously at a speed determined by the facilitator.

Variation 10, Peverse

Players are instructed to reverse the direction they pass the blocks without breaking the continuous rhythm of the game. Under the guidance of the facilitator, players change direction of passing the blocks without switching hands. When blocks are being passed counterclockwise a reverse will mean passing them clockwise, and will mean passing them counterclockwise if they are being passed clockwise. A reverse can be applied to anyone of the variations.

Variation 11: Competition

Competition can be applied in any of the abovementioned variations. Players have to pay very close attention to the game so they will not miss any of the cues to change the pace, direction or variation. It is important to listen closely to the facilitator. When a player loses their concentration, the rhythm is broken, blocks overflow in one area of the circle and disappear in another; that means the game has to stop.

The decision of who, if anyone, must eventually leave the circle is up to the facilitator. If a player is eliminated, he or she will still play a part in the game by clapping and walking around the perimeter of the circle, helping the remaining players keep up the pace. Eliminated players do not participate in the moving of blocks, but they are simply assigned different tasks. It's important to remember that no one loses in this game.

Apparatus

In reference to the apparatus described in the drawing section, game blocks may be made from material selected from the group consisting of wood, plastic, sponge or foam. They may also be sewed spheric sacs made from clothing materials or leather, of no more than 2 inches diameter and containing sand.

Blocks made of wooden material may be cubical or in any form or any dimensions that a human hand can hold, cut from wood and well sanded on the surfaces and with broken angles and rounded corners.

Blocks made from plastic or foam materials may be cut from larger pieces of such materials, or cast in prefabricated molds.

All blocks must be small enough to fit into human hands, and large enough to be picked up by human fingers without difficulty. The preferred block material is wood and the recommended size, form and shape may be 1½ inches per side cubical block , with sanded surfaces, broken angles and rounded corners.

It is apparent from the above that the present invention accomplishes all of the objects set forth by providing a new and creative process of team building game, with an apparatus that is low in cost, relatively simple in design and operation.

While the present invention has been fully described above, these descriptions are given for purposes of explanation. Variations, changes, modifications and departure from the methods and variations disclosed above may be adopted without departure from the spirit and scope of the present invention.

In a preferred embodiment, the playing area such as a floor is shaped as a circle, a square or a rectangle. However, an area of any other practical geometrical configuration, closed, is contemplated by this invention.

The above description of players' placement and variations should be not construed as limitations on the scope of the invention. Many other variations are possible. Accordingly, the scope of the invention is determined by the claims and their and their legal equivalents.

What is claimed is:

1. A method of playing a team building game by a group of players, sitting on the floor or at desks, using blocks as playing tools, and passing blocks simultaneously, rhythmically and continuously to their neighbors while singing the accompanying song, at speed, direction and variation determined by the game facilitator.

2. A game facilitator of claim 1, whose role is to arrange players in the playing area, instruct the players on the game procedures, teach the song and sing the solo during the game, decide on the duration, variation and speed of each round, and proceed to the elimination of players when necessary.

3. A placement of players of claim 1, wherein they are sitting on the floor in a closed circle each with players extending their legs behind the person in front of them, forming a playing area, close to each other enough to allow game blocks to be deposited in front of neighboring players.

4. A placement of players of claim 1, wherein they are sitting or standing around desks, in a closed circle forming a playing area, close to each other enough to allow game blocks to be deposited in front of neighboring players.

5. A game apparatus of claim 1, comprising of blocks made from material selected from the group consisting of wood, plastic, sponge or foam, but also sewed spheric sacs made from material selected from clothing materials or leather and filled with sand.

6. A team building and educational game which is susceptible of a low cost of manufacture with regard to both materials and labor, and which accordingly is then susceptible to low prices of sale to the consuming public, thereby making such educational game available to a larger public.

7. A game playing variation of claim 1, wherein players pass blocks counterclockwise with players picking the blocks up in front of them and pass them to their neighbors to the right.

8. A game playing variation of claim 1, wherein players tap their blocks twice in front of them before passing them.

9. A game playing variation of claim 1, wherein players tap the blocks three times in front of them before passing them.

10. A game playing variation of claim 1, wherein players pick up the blocks, first tap them in front of the players at their left, then bring the blocks back and tap them in front of themselves and finally pass them to the players to their right.

11. A game playing variation of claim 1, wherein players pick up the blocks, first tap them in front of the players on their left, then in front of themselves, then in front of their players on their right, then back in front of themselves, then in front of their neighbor on their left again, then in front of themselves and finally, they pass the blocks players to their right.

12. A game playing variation of claim 1, wherein players draw the capital letter “L” by picking up their blocks, tap them first towards the middle of the circle with their arm extended, then bring them back to tap in front of themselves, and finally pass the blocks to their neighbors.

13. A game playing variation of claim 1, wherein players pick up their blocks, tap them first towards the middle of the circle with their arm extended, then in front of themselves, then tap them in front of their neighbors on their left, then in front of themselves, then towards the middle of the circle with their arm extended, then bring them back to tap in front of themselves, and finally pass the blocks to their neighbors.

14. A game playing variation of claim 1, wherein players pick up their blocks, tap them first towards the middle of the circle with their arm extended, then lift up their blocks approximately at the level of their eyes, then tap them down again at the extended position, then in front of them, and finally pass them to their neighbors.

15. A game playing variation of claim 1, wherein players keeping both hands closed, pick up the blocks with their right hand, cross their arms and tap the blocks in front of your neighbor at their left while their left fists go towards their neighbor at their right; players then uncross their arms, bring back the blocks and tap them in front of themselves, before tapping them in front of their neighbors.

16. A game playing variation of claim 1, wherein players are instructed to reverse the direction they pass the blocks without breaking the continuous rhythm of the game, by passing the blocks clockwise when blocks are being passed counterclockwise, or counterclockwise if they are being passed clockwise.
